(19) United States
(12) Patent Application Publication
(10) Pub. No.: US 2014/0370152 A1
(43) Pub. Date: Dec. 18, 2014

(54) QUICK PICKLE FERMENTATION CURE

(71) Applicant: FERMENTING SOLUTIONS INTERNATIONAL, LLC, Emerald Isle, NC (US)

(72) Inventor: William A. Scott, Emerald Isle, NC (US)

(73) Assignee: FERMENTING SOLUTIONS INTERNATIONAL, LLC, Emerald Isle, NC (US)

(21) Appl. No.: 14/300,981

(22) Filed: Jun. 10, 2014

Related U.S. Application Data
(63) Continuation of application No. 14/057,086, filed on Oct. 18, 2013.

(51) Int. Cl. A23L 1/218

(52) U.S. Cl. CPC A23L 1/218
USPC 426/52

(57) ABSTRACT

The fermentation of cucumbers and other vegetables into pickles is traditionally a long term process. By exposing the flesh of the vegetable and pickling with calcium chloride instead of sodium chloride, a faster fermentation pickle is achieved with no decrease in quality.

This application is a continuation of U.S. non-provisional patent application Ser. No. 14/057,086 filed on Oct. 18, 2013, and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method of production of a cured pickle product by fermentation. In particular, the present invention is directed to a method of producing a fermentation cured pickle product quickly without the traditional fermentation length.

2. Description of Related Art

The fermented pickle product, such as cucumbers and the like, is popular the world over because of the flavor and appearance that distinguishes them from other types of pickle products.

Commercially produced pickles are fermented in a brine solution of about 6% sodium chloride in large open top tanks as large as 40,000 liters. The salt in this type of fermentation serves more than one function. It is used to prevent freezing of outside tanks in northern climates, however, the most important function is it selects for salt tolerant bacteria, such as Lactobacillus plantarm. Salt tolerant bacteria are normally used for fermentations of this type. It helps maintain the firm texture of the fermented product while they are stored up to a year in fermentation tanks and it provides salty flavor in the products made from the fermented fruit such as a cucumber. Open tanks have the problem of allowing undesirable microbes and other items to enter the fermentation easily.

Traditional fermentation can take from about three to four weeks to finish the fermentation process sufficiently for commercial sale. This limits the amount of pickles produced with equipment to several batches per year in optimal conditions. Tank yard operations in the traditional fermented process involve a large amount of labor and capital with respect to maintaining the tank yard for the extended process times. An additional continuing issue for commercial pickle production is the disposal of the salt in a manner that meets current standards for disposal with some local governments severely restricting the amount of salt which can be disposed of. Recycling of the brine from each fermentation batch has shown some benefit in sodium chloride reduction. However, the intermingling of brines from different sources, batches, etc during recycling with more diverse microbial content present a carryover of “off” or unwanted flavors in the finished product.

Calcium chloride is well known in the pickling process for having an effect when added to the conventional pickling process in that it increases the firmness of the preserved fruit especially with cucumbers. Calcium chloride is considered more environmentally friendly than sodium chloride and the disposal of calcium chloride is less of an issue in terms of it being a waste product. Whole cucumber pickles have been utilized in a process involving only calcium chloride and the results indicated that a similar result in terms of time of brining and food product result that can be obtained without use of sodium chloride. Since no time difference was observed, the processes used did nothing to deal with the length of time it takes to ferment pickles and the problems with low equipment use turnover.

### BRIEF SUMMARY OF THE INVENTION

The present invention relates to the discovery of a process of fermenting pickles with calcium chloride such that the pickling time is greatly reduced and the turnover rate of fermentation tanks is much higher. By cutting, slicing or piercing the produce prior to the pickling process, such greatly reduced fermentation times are achieved.

Accordingly in one embodiment the present invention relates to an accelerated method of pickling fresh produce comprising the steps of:

a) exposing at least a portion of the internal flesh of the fresh produce;

b) adding the fresh produce to a fermentation container consisting essentially of a solution of water; a pickling fermentation culture, calcium chloride of about 0.5% to about 2.0% on w/w basis of the water; and a yeast and mold inhibitor;

c) maintaining the solution at a temperature of about 25 C to about 35 C for a period of time sufficient to pickle the fresh produce.

### BRIEF DESCRIPTION OF THE DRAWINGS

FIG. 1 is an example of the mechanical arrangement of the method of the present invention.

FIG. 2 is an example of cucumbers that have been sliced, cut (diced) and pierced.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

Normally the fermentation of a vegetable in a brine solution takes on the order of several weeks to several months to complete the fermentation on a commercial scale. As used herein the term “accelerated refers to completion of the pickling process in under two weeks. In one embodiment under a week and in one embodiment completion is within 1, 2, 3, 4, 5, 6 or 7 days. In one example, cubed cucumber using sodium chloride fermentation would take 8-14 days to complete fermentation (i.e. all sugars fermented). In the present invention, the same cubed cucumbers would be completely fermented in 48 hours reducing the fermentation time to ⅕ the original time.

As used herein the term “pickling ” in the claims refers to the brine fermentation curing of vegetables in a solution of calcium chloride of a concentration of about 0.5% to about 2.0% on a w/w basis of the water in the brine. In addition, a suitable pickling culture such as Lactobacillus plantarum or the like bacteria is utilized or added to create the fermentation. In one embodiment, the brine consists essentially of calcium chloride and no other brining ingredients. The brine, in one embodiment, can also contain herbs and spices as well as known yeast and mold inhibitors known in the art of food processing. For example, potassium sorbate inhibits both yeast and molds and could be utilized. In one embodiment it is added in a concentration of about 0.1%.

As used herein the phrase “exposing at least a portion of the internal flesh of the fresh produce” refers to the act of cutting, slicing, dicing, piercing or the like such that a physical exposure of the internal flesh of the vegetable occurs and the brine can come into contact with the exposed flesh. One can expose as little or as much as desired but larger amounts of exposed flesh as by slicing, for example, give the greatest exposure to the flesh.

Once the flesh is exposed, the exposed vegetable is optionally water washed for a time sufficient to allow for a reduction in the sugars present in the fresh produce. This step allows for a further reduction in fermentation time than without this step. The time, in general, for the wash is roughly 3 minutes. One skilled in the art can determine the optimum soak time depending on the particular vegetable and the amount of interior flesh that is exposed, the size of the vegetable, and the like in view of this disclosure. Once the soaking step is completed the wash water is removed by means known in the art. In one embodiment it is done by use of a hydrosieve. Fresh water is removed before beginning the fermentation step (optionally the wash water is utilized in the fermentation step).

The produce is then added to a fermentation tank then covered with water and enough calcium chloride added to make a solution of about 0.5% to about 2% w/w/ as described above. In one embodiment, the solution is made isotonic. Since this method is designed primarily for commercial size production, the fermentation vessel in one embodiment is at least 19,000 liters (though any size big enough to fit a single piece of a product or larger will work) and the tank is filled with produce to a level of about 45% product and 55% solution though the range is from about 30/70 to 70/30 volume basis. In one embodiment, the tank has a closed top to prevent entry of random bacteria and other unwanted items. In addition, the culture and mold and yeast inhibitors are added as well. The solution is brought to a temperature ideal for the fermentation of a lactobacillus fermentation of about 25 to 35 degrees C. and held for a length of fermentation time as described above.

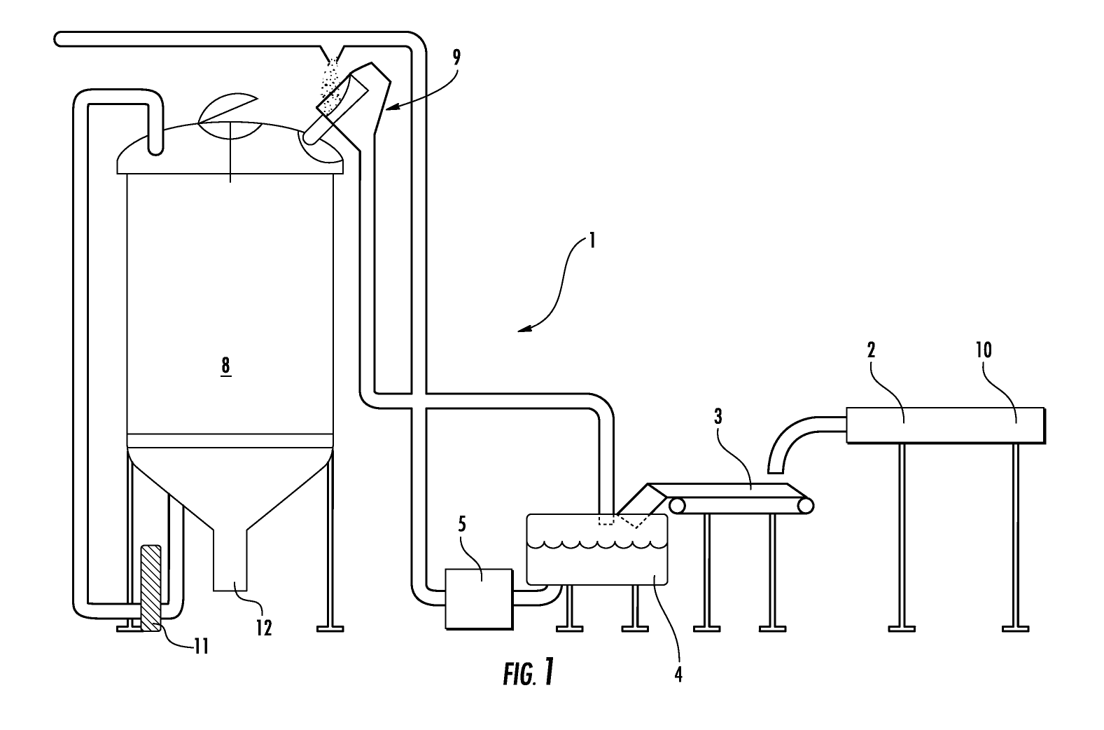

Now referring to the drawings, FIG. 1 shows a commercial production arrangement 1 using the method of the present invention. In this view, a commercial step for exposing the flesh of the produce 10 is done at cutter/dicer 2. The produce is then transferred to shaker screen 3 which removes small unwanted pieces and debris while transferring the produce to a wet tank 4 for the soaking step as described above. Next, water transfer pump 5 transfers the water and produce to the commercial fermentation tank 8 after the wash water is optionally removed via hydro sieve 9 positioned right before the produce enters the fermentation tank 8. The appropriate calcium chloride, the fermentation culture flavorings, water and the like are added to the tank. A heat exchanger 11 keeps the fermentation at the appropriate temperature e.g. 30 degrees C. for the desired time and then water and produce are removed via fermentation tank drain 12 to the bottom of fermentation tank 8 via gravity once the pickles are fermented completely to the desired degree.

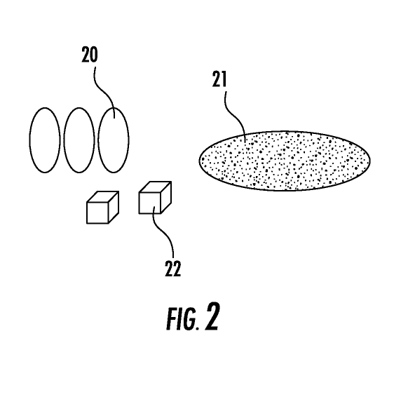

FIG. 2 shows cucumbers that have been sliced 20, pierced 21 and diced 22 for addition to the fermentation process of the present invention.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. An accelerated method of pickling fresh produce comprising the steps of:
a) exposing at least a portion of the internal flesh of the fresh produce;
b) adding the fresh produce to a fermentation container consisting essentially of a solution of water; a pickling fermentation culture, calcium chloride of about 0.5% to about 2.0% on w/w basis of the water; and a yeast and mold inhibitor;
c) maintaining the solution at a temperature of about 25 C to about 35 C for a period of time sufficient to pickle the fresh produce.

2. The picking method according to claim 1 wherein the yeast and mold inhibitor is potassium sorbate.

3. The pickling method according to claim 1 wherein the calcium chloride is present at about 1% w/w of the water solution.

4. The pickling method according to claim 3 wherein the solution is isotonic.

5. The pickling method according to claim 1 comprises the additional step of water washing the fresh produce for a time sufficient to allow for a reduction in the sugars present in the fresh produce and prior to the fermentation step b).

6. The pickling method according to claim 1 wherein the internal flesh of the fresh produce is exposed by at least one of cutting, slicing, dicing and piercing the fresh produce.

7. The pickling method according to claim 1 wherein the wash water is removed by a hydrosieve.

8. The pickling method according to claim 1 wherein the container has a closed top.
